(19) United States
(12) Patent Application Publication
(10) Pub. No.: US 2026/0302607 A1
(43) Pub. Date: Oct. 1, 2026

(54) ELECTRICALLY CONDUCTIVE GROUNDING STRUCTURE FOR A MULTI-BAND ANTENNA

(71) Applicant: Telefonaktiebolaget LM Ericsson (publ), Stockholm (SE)

(72) Inventor: Muhammad Imtiaz, Rosenheim (DE)

(21) Appl. No.: 19/481,458

(22) PCT Filed: May 11, 2023
(86) PCT No.: PCT/EP2023/062543

§ 371 Date: Nov. 4, 2025

(51) Int. Cl. H01Q 1/52; H01Q 1/24; H01Q 1/50; H01Q 5/30; H01Q 19/10; H01Q 21/06

(52) U.S. Cl. CPC H01Q 1/523; H01Q 1/246; H01Q 1/50; H01Q 5/30; H01Q 19/104; H01Q 21/062

(57) ABSTRACT

An electrically conductive grounding structure for at least one high band radiating element of a multiband antenna to a high band antenna element, to a multiband antenna and to a base station. The grounding structure comprising a main body portion, and at least one ground line. The main body portion having further at least one ground contact. The ground contact is assigned to and electrically connected with the at least one ground line, wherein the at least one ground contact is provided in a distance d from a foot end of the assigned ground line.

### FIELD OF THE INVENTION

The present invention relates to an electrically conductive grounding structure for a radiating element of a multiband antenna, particularly for a high band radiating element, to a high band antenna element and to a multiband antenna including at least one electrically conductive grounding structure as well as to a base station including at least one multiband antenna, wherein the multiband antenna and/or base station may be part of a cellular and/or communication system.

### BACKGROUND

Recent developments in cellular and communication technology and an ever-in-creasing requirement of high-speed networks typically require new, improved antenna equipment in the network, including a multiband antenna environment.

For example, cellular and communication technology requires multiple antennas being installed at a site. This may result in towers being cluttered with multiple antennas while installation and maintenance becomes increasingly complicated. To reduce the amount of individual antennas, multiband antennas or ultra-wideband dual-polarized antennas have been designed for cellular base stations. In such multiband dual-polarized antennas, low band antennas (or low band radiating elements) are interspersed with high band antennas (or high band radiating elements).

However, the common mode, CM, resonance of a high band radiating element/antenna in a low band frequency distorts the radiation patterns of the low band radiating elements/antennas.

Generally, CM resonance is a type of resonance that occurs in electrical circuits such as radiators when a common mode signal excites a resonance in the circuit. Particularly, CM resonance occurs in circuits that have two or more conductors that carry signals relative to ground. It is a phenomenon that can cause unwanted noise, interference, poor signal quality, reduced range and even damage to electronic devices, such as radios or antennas.

Further, in cellular and communication networks, CM can disturb the portion of the electromagnetic signal that is transmitted or received by an antenna in the transmitting and/or receiving frequency band, typically in the lower operation frequency It affects the entire system and degrades the quality of the communication, due to e.g. signal distortion, data errors, and other communication issues. To mitigate the effects of CM resonance and/or noise in cellular networks, various techniques are used, such as using balanced circuits, isolating sensitive components from sources of noise, and filtering out unwanted signals. These techniques help to reduce the impact of CM resonance and/or noise on the network and im-prove the overall quality of communication. However, those techniques are often-times costly to implement and increase the complexity of the entire system.

Regarding multiband antennas and a respective multiband antenna environment, the radiation patterns of a low band element can be distorted by resonances developed in a high band element, for example, when a high band operating frequency is about 2 to 3 times the low band operating frequency.

In common cellular networks, the GSM 1800 or LTE 1800/2100 band is approximately twice the frequency of the GSM 900 or LTE 1800/2100 band, respectively. Accordingly, a radiating element of the GSM900 band in the absence of a radiating element of the GSM1800 band may have half power beam width of approximately 65 degrees. However, when GSM 1800 band radiating elements are placed with GSM900 band radiating element(s) on the same multiband antenna environment, CM resonance of the GSM1800 band element may cause an undesirable broadening of the half power beam width at 900 MHz.

Further radiating elements of multi band antennas, particularly of interspersed multi band antennas CM resonance may lead to undesirable interactions. For example, in some cellular applications, low band is 698-960 MHz and high band is 1.695-2.69 GHz. Undesirable interactions between these bands may occur when the high band resonating structure resonates at the frequency of the low band (e.g. as if it were an one quarter wave monopole). This may result in distortion of the radiation patterns, variations in beam width, beam squint and high cross-polar radiation in low band.

One specific approach for reducing CM resonance is described in U.S. Pat. No. 9,711,871 B2, which suggests a high band radiator of an ultra-wideband dual-band base station antenna. The high band radiator comprises at least one dipole, a feed stalk, and a tubular body made of conductive material and having an annular flange. The feed stalk feeds the dipole and comprises a non-conductive dielectric substrate body and conductors formed on the substrate body to function as a balun transformer. The feed stalk is connected with the dipole at one end and has at least one feed connector at the other, with the conductors coupled there-between.

US 2018/323 513 A1 relates to a dual-polarized radiating element for a base station antenna that includes a first dipole and a second dipole, each dipole having respective dipole arms. The sizes of respective gaps between adjacent ones of the dipole arms may be selected in order to tune a common mode resonance.

### SUMMARY

In view of the above, the object of the present invention is to reduce mitigating CM resonances, particularly in multiband antennas, such as interspersed multi band antennas. Further, this invention is aimed at minimizing the undesirable effects of high band radiating elements on radiation performance of low band radiating elements. It is to be noted that the present invention is not limited to communication and cellular technology and may be used in any other multiband applications, where high band radiating elements and low band radiating elements are present.

The object is achieved by an electrically conductive grounding structure for a high band radiating element of a multiband antenna, by a high-band antenna and by a multiband antenna including at least one electrically conductive grounding structure and by a base station including at least one multiband antenna, as defined in the independent claims. Further aspects of the present invention are given in the dependent claims as well as throughout the following description.

According to an aspect of the invention, there is provided an electrically conductive grounding structure for at least one high band radiating element of a multiband antenna.

Generally, a multiband antenna is a type of antenna that is capable of operating on multiple frequency bands (e.g. GSM1800 band as high band and GSM900 band as low band, or LTE 1800/2100 as high band and or LTE 800 as low band). This means that it can receive and transmit signals on different frequencies at the same time, hence multiple wireless communication technologies can be supplied simultaneously, such as cellular, Wi-Fi, and/or Bluetooth, allowing to support different networks and devices.

A high band radiating element is a part of said multiband antenna that is designed to operate at high frequencies. It is typically a conductive structure that is used to emit and/or receive electromagnetic waves in the high-frequency range, which can include frequencies in the VHF, UHF, and microwave bands.

Typically, all radiators, the form of a reflector and additional passive structure elements in front of the reflector which are mounted in the active radiating space before the reflector will influence more or less each other with respect to impedance, radiation characteristic and isolation. In a multiband antenna, there may be multiple radiating elements designed to operate at different frequency bands and/or polarizations. Examples of high band radiating elements, but not limited thereto, include dipole antennas, patch antennas, and micro strip antennas. In a particular aspect, a multiband antenna may include two differently polarized radiating elements, forming a dual polarized radiator, such as a dual polarized dipole. The differently polarized radiating elements may have a +/−45-degree linear polarization, which is orthogonal to each other.

The electrically conductive grounding structure according to the present invention comprises a main body portion, and at least one ground line. The ground line extends from the main body portion, particularly from a foot end thereof in a first direction y towards a head end. The ground line may extend to reach the head end or may only extend towards the head end.

The foot end is provided at the main body portion (i.e. it forms a connecting area between the main body portion and the ground line). The head end is opposed to the respective foot end and is adapted to support the at least one high band radiating element. For supporting the high band radiating element, the high band radiating element may be connected to (mechanically and/or galvanically) to the head end.

Further, the main body portion has at least one ground contact, or at least two ground contacts. The ground contact(s) is/are assigned to and electrically connected with the at least one ground line, wherein the at least one ground contact is provided in a distance d from the foot end of the assigned ground line. The distance d is measured in a second direction x being different than the first direction y. Further, the distance d is chosen so as to shift the common mode, CM, resonance of the at least one high band radiating element out of a used frequency range of a low-band radiating element of the multiband antenna. In a particular example, the distance d may be chosen for a GSM900/GSM1800 multiband antenna to be in a range from 48 mm to 58 mm, or in a range from 51 mm to 55 mm, or to be about 53 mm.

Instead of grounding the high band radiating element(s) directly below the head (d=0), as in common multi band antennas, the inventive electrically conductive grounding structure allows to provide ground contact(s) at a defined distance d. Said distance d is chosen so as to minimize the effects of common mode resonance generated by the high band radiating element (or respective dipole arms thereof).

Further, the CM resonance can be shifted out of the low band frequency/frequencies of the multiband antenna. Hence, mutual coupling between high and low band radiating element(s) can be reduced by increasing the coupling current path.

Even further, it has shown that choosing the distance d allows to minimize the effects of common mode resonance, while not detuning the high band radiating element(s). Further, the performance of the low band element(s) of the multiband antenna is not detruded either.

Still further, the proposed electrically conductive grounding structure provides a very compact design and does not require to increase the dimension of the radiating element(s) and their feeding structure to implement CM resonance avoidance solution.

In a particular aspect, the electrically conductive grounding structure may include multiple ground lines. Each ground line may extend towards a respective head end and may be assigned to a respective high band radiating element of a multi-band antenna. The high band radiating element may be e.g. a dipole antenna, a patch antenna, a micro strip antenna or any other type of high-band antenna. In case of using dual polarized antennas, such as dual polarized dipoles, a first ground line may be assigned to a first pair of dipole arms (first polarization) and a second ground line may be assigned to a second pair of dipole arms (second polarization).

Here, the main body portion may further comprise multiple ground contacts, wherein at least one ground contact of the multiple ground contacts is assigned to and electrically connected with a respective one of the ground lines. In a particular aspect each ground line may have at least one assigned ground contact. Further, some (or all) of the ground lines may have just one assigned ground contact, while other ground lines may have multiple (e.g. two) assigned ground contacts. Further, neighboring ground lines may have a shared (common) ground contact being provided or even centered between the neighboring ground lines.

The ground contacts are provided in a distance d from a foot end of the assigned ground line. The distance of all ground contacts may be equal, resulting in a substantially symmetric setup, or may be different. In a particular aspect the distance d of the ground contacts being assigned to ground lines of a particular high-band antenna (e.g. a dual polarized dipole) may be provided in equal distances d.

The distance d is measured in a second direction x. This second direction x is different than the first direction y. As above, the distance d of the respective ground contacts is chosen so as to shift the common mode, CM, resonance of the respective high band radiating elements out of a used frequency range of a low-band radiating element of the multiband antenna. Hence, the advantages given above can be achieved with antennas having multiple high-band radiating elements and/or multiple low band radiating elements.

Further, in case of multiple ground contacts, the combination of a ground contact being provided on a right hand side of a foot end of a first ground line (distance d) being assigned to a first high band radiating element with a first polarization (e.g. +45 degree) and a ground contact being provided on a left hand side of a foot end of a second ground line (distance d) being assigned to a second high band radiating element with a second polarization (e.g. −45 degree) can act as a filter to remove CM resonance at the low band for both polarizations of a high band antenna element having two differently polarized radiating elements. The first high band radiating element and the second high band radiating element may form a dual polarized radiator, such as a dual polarized dipole. The differently polarized radiating elements may have a +/−45-degree linear polarization, which is orthogonal to each other.

In a particular aspect, the distance d of a first ground contact being assigned to a first ground line equals a distance d of a second ground contact being assigned to a second ground line, wherein the first and second ground lines may be assigned to a dual polarized high band radiating element. This substantially symmetrical setup has shown to reduce CM resonances effectively.

Further, the electrical line length between a ground contact and a foot end of an assigned ground line may be longer than the distance d measured in the second direction x. Particularly, the electrical line length may be lengthened by means of a meandering electrical line. In a particular aspect, the electrical line length between a first ground contact and a foot end of an assigned first ground line may be longer than the distance d of the first ground contact and equal to a distance d of a second ground contact or an electrical line length between the second ground contact and a foot end of an assigned second ground line. The electrical line length between the second ground contact and a foot end of the assigned second ground line may be longer than the distance d of the second ground contact. The electrical line length between the second ground contact and the respective foot end may also be lengthened by means of a meandering electrical line.

The electrical line length may be chosen so as to shift the common mode, CM, resonance of the at least one high band radiating element out of a used frequency range of a low-band radiating element of the multiband antenna.

The at least one ground contact may be a capacitively coupled ground contact or a galvanically coupled ground contact. The ground contacts may be coupled to a ground plane of a feeding structure and/or to a reflector element of the multiband antenna.

The galvanic coupling may be achieved by soldering, welding, by screwing, riveting and/or any other known coupling method. The capacitive coupling may be achieved by providing respective electrodes on the ground contact and the element the ground contact shall be coupled with (e.g. a reflector element or a ground plane of a feeding structure). By providing the ground contact spaced apart from the element the ground contact shall be coupled with, the capacitive coupling is achieved. A gap between the ground contact and the element the ground contact shall be coupled with may be filled (at least partially) with an electric insulator and/or a dielectric medium.

The electrically conductive grounding structure may comprise or may be made of a sheet metal, a die cast, a micro-strip line or a PCB, particularly of a single metallization layer of the PCB.

A sheet metal based electrically conductive grounding structure is robust and allows for cost effective manufacturing, as the electrically conductive grounding structure can be obtained by stamping and bending metal sheets. Die casting also allows for a cost effective manufacturing and provides for a more flexible design. When using sheet metals or die cast, a respective signal transmission line for feeding the radiating element can be provided substantially parallel (at least in part) to the respective ground line, while being separated and electrically insulated from the respective ground line.

Micro strip lines as well as PCBs allow to integrate a feeding structure in the electrically conductive grounding structure, wherein the feeding structure serves for feeding transmission signals to the respective radiating elements. For example, a signal transmission line for feeding the radiating elements can be provided on the micro strip line and/or the PCB, wherein the signal transmission line is separated from the electrically conductive grounding structure (and respective ground lines) by the micro strip line's or PCB's substrate (i.e. a dielectric medium).

In other words, the electrically conductive grounding structure may include an integrated feeding structure. The integration requires, that the signal transmission line(s) for feeding the radiating element(s) is/are insulated from the ground lines of the electrically conductive grounding structure. Thus, the electrically conductive grounding structure can serve as an integrated feed board for as single or multiple high band radiating elements.

The electrically conductive grounding structure may further comprise at least one feeding point. The feeding point being assigned to the high band radiating element supported by the ground line (and optionally a respective signal transmission line). The feeding point serves for connecting a coaxial signal line, via a signal transmission line to a respective high band radiating element. The connection direction of the coaxial signal line may be the first direction, or a direction being substantially perpendicular to the first direction and second direction. Hence, the electrically conductive grounding structure can be adapted to a desired cable routing, as the connection direction of a coaxial signal line (coaxial cable) can be adjusted to a desired angle (e.g. vertical or horizontal, or any angle in-between).

The feeding point may be localized in close proximity to a foot end of the assigned ground line. The location of the feeding point may be chosen so as to shift the common mode, CM, resonance of the at least one high band radiating element out of a used frequency range of a low-band radiating element of the multiband antenna. Thus, by choosing the location of the at least one feeding point, undesired CM resonance can be further suppressed.

In a particular aspect, the electrically conductive grounding structure may further comprise at least one signal transmission line. The at least one signal transmission line may connect a feeding point with an assigned high band radiating element for transmitting transmission signals.

In a further aspect, the electrically conductive grounding structure may comprise at least two signal transmission lines. Hence, the signal transmission lines may be integrated in the electrically conductive grounding structure. Each one of at least two signal transmission lines may connect a respective feeding point with an assigned high band radiating element for transmitting transmission signals. The signal transmission line(s) may be electrically insulated from the ground line(s) of the electrically conductive grounding structure, e.g. by a micro strip line's or PCB's substrate.

Particularly, a first signal transmission line may connect a first feeding point with an assigned first high band radiating element and a second signal transmission line may connect a second feeding point with an assigned second high band radiating element. The first and second high band radiating elements may form a dual polarized radiator, wherein the first high band radiating element may have a first polarization (e.g. +45 degree) and wherein the second high band radiating element may have a second polarization (e.g. −45 degree). The object is further achieved by a high band antenna element for a multiband antenna, the high band antenna element including at least one high band radiating element and a signal transmission line, wherein the high band radiating element is fed by the signal transmission line. The high band antenna element further including an electrically conductive grounding structure as described above, wherein the electrically conductive grounding structure is assigned to the at least one high band radiating element (e.g. may support the at least one high band radiating element at a head end), and wherein the signal transmission line(s) may be integrated in the electrically conductive grounding structure.

The high band antenna element may include at least one dual polarized dipole, wherein a first high band radiating element provides a first polarization, and a second high band radiating element provides a second polarization. Further, the high band antenna element may include multiple dual polarized dipoles (e.g. at least four, or at least six).

Each of the high band radiating elements may be fed with a respective signal transmission line, wherein the signal transmission line may connect the high band radiating element with a respective feeding point. Further, the signal transmission line may be integrated in an electrically conductive grounding structure, as outlined above.

The object is further achieved by a multiband antenna. The multiband antenna comprises at least one low band radiating element (or a plurality of low band radiating elements, i.e. at least two) and at least one high band radiating element (or a plurality of high band radiating elements, i.e. at least two, preferably at least four, or at least six). Further, the multiband antenna comprises at least one electrically conductive grounding structure as described above, wherein a ground line of the electrically conductive grounding structure is assigned to the at least one high band radiating element. Further, at least one signal transmission line may be provided for feeding a respective one of the high band radiating element(s). Said signal transmission line may be integrated in the electrically conductive grounding structure. Hence, the electrically conductive grounding structure may serve as feed board for some or all of the high band radiating elements. This allows to simplify the overall structure and reduce costs.

It is to be noted that the present invention is not limited to a dual band environment only (i.e. high band and low band), but may be implemented to multiband environments where there is plurality of different low band and high band radiating elements.

In a particular aspect, the at least one low band radiating element may be provided as an interspersed low band radiating element, thereby leading to a compact antenna design.

Further, at least one of the radiating elements may be fed with one of a sheet metal, a die cast a micro strip line and/or at least one PCB. Hence, the signal transmission line(s) may be provided as a sheet metal or a die cast or on a micro strip line and/or on at least one PCB. In a particular aspect, the signal transmission lines may be integrated in the electrically conductive grounding structure.

In a particular aspect, each radiating element (high band and/or low band) may be fed by a single PCB, wherein the PCB may be a dual layer PCB. A first layer of said dual layer PCB may be assigned to the ground line(s) and a second layer to the signal transmission line(s). The ground line(s) and signal transmission line(s) may be arranged so as to provide a balun element (e.g. a marchand balun or any other balun structure).

Further, the multiband antenna may include a parasitic metal. The parasitic metal may be provided so as to sandwich a high band radiating element between the parasitic metal and a head end of a ground line of the electrically conductive grounding structure. The parasitic metal can be shaped and oriented so as to enhance the performance of the antenna by changing the radiation pattern or the impedance of the antenna.

Further, the multiband antenna may comprise a reflector element and/or a base plate, wherein the reflector element may be arranged between the main body portion and the at least one high band radiating element, and wherein the at least one ground contact of the electrically conductive grounding structure may be coupled to the reflector element and/or the base plate. The coupling may be galvanically and/or capacitively.

In a particular aspect, the electrically conductive grounding structure and particularly the ground lines (and optionally signal transmission lines thereof) may intersect the reflector element. In other words, the electrically conductive grounding structure and particularly the ground lines (and optionally signal transmission lines thereof) may extend through the reflector element. The reflector element may provide at least one though opening (e.g. at least one slot) for receiving the reflector-intersecting electrically conductive grounding structure.

The form and/or size of the at least one through opening (e.g. slot) may be chosen so as not to disturb the radiation pattern. Further, by sandwiching a through opening of the reflector between respective ground contacts of the electrically conductive grounding structure, undesired resonances can be avoided.

Further, the at least one high band radiating element of the multiband antenna may be fed with a signal transmission line, the signal transmission line being arranged in parallel to the ground line, particularly broadside coupled.

The object may be further achieved by a base station for mobile communication, the base station including at least one multi-band antenna as outlined above, and at least one radio unit being assigned to said multi-band antenna.

### BRIEF DESCRIPTION OF THE DRAWINGS

Further features and advantages will be apparent from the following description as well as the accompanying figures, to which reference is made. The figures show in detail:

FIG. 1 a schematic illustration of a base station according to an embodiment;

FIG. 2 a schematic illustration of a multiband antenna according to an embodiment;

FIG. 3 a schematic illustration of a further multiband antenna according to an embodiment;

FIG. 4 a schematic illustration of an electrically conductive grounding structure according to an embodiment;

FIG. 5 a schematic illustration of a further electrically conductive grounding structure according to an embodiment;

FIG. 6 a schematic illustration of a further electrically conductive grounding structure according to an embodiment;

FIG. 7 a schematic illustration of a further electrically conductive grounding structure according to an embodiment;

FIG. 8 a schematic illustration of a further electrically conductive grounding structure according to an embodiment;

FIG. 9A a detailed view of an electrically conductive grounding structure (signal transmission line side);

FIG. 9B a detailed view of an electrically conductive grounding structure (ground line side);

FIG. 10 a graph illustrating the half power beam width of an inventive antenna, and

FIG. 11 a graph illustrating a 10 dB beam width of an inventive antenna.

### DETAILED DESCRIPTION

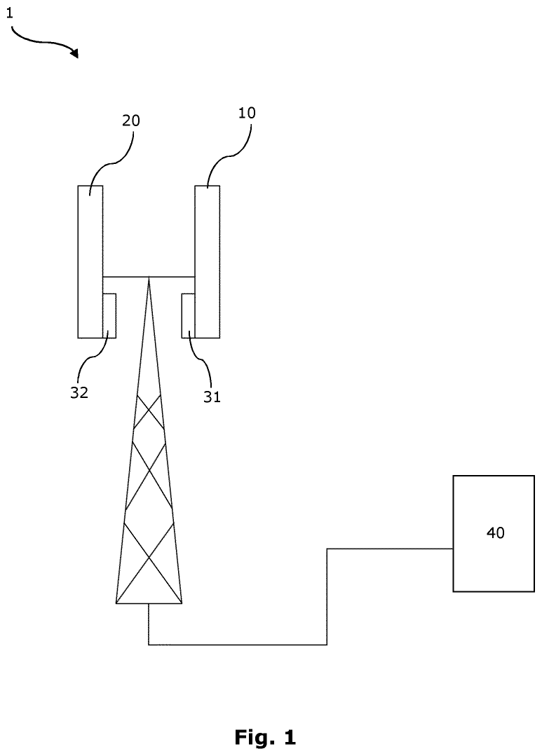

FIG. 1 shows a schematic illustration of a base station 1 according to an embodiment. The base station 1 incudes a control unit 40, such as a based band unit (BBU), which is in communication with radio units 31, 32. Those radio units 31, 32 may be remote radio units, which may be remotely controlled by the control unit. The radio unit 31 is assigned to a first multi band antenna 10 of the base station 1 and the radio unit 32 is assigned to a second multi band antenna 20 of the base station 1. Each one of the multi-band antennas 10, 20 may include a remote control unit for enabling e.g. controlling phase shifters of the respective multi-band antenna by means of the control unit 40. Hence, remote electrical tilt (RET) can be provided.

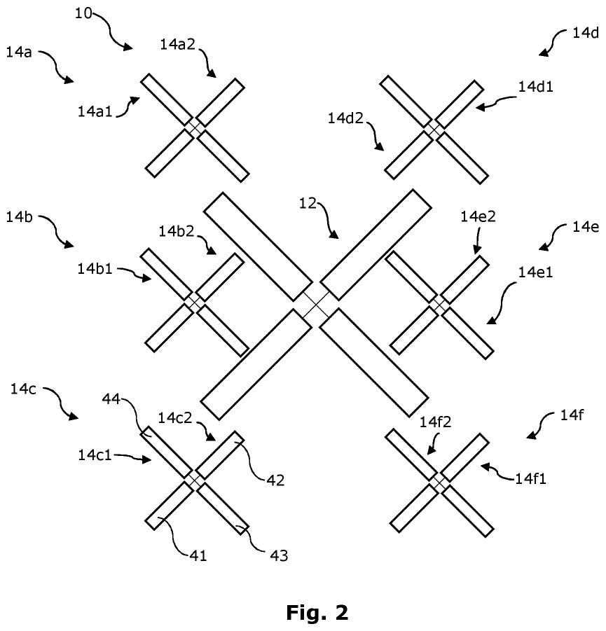

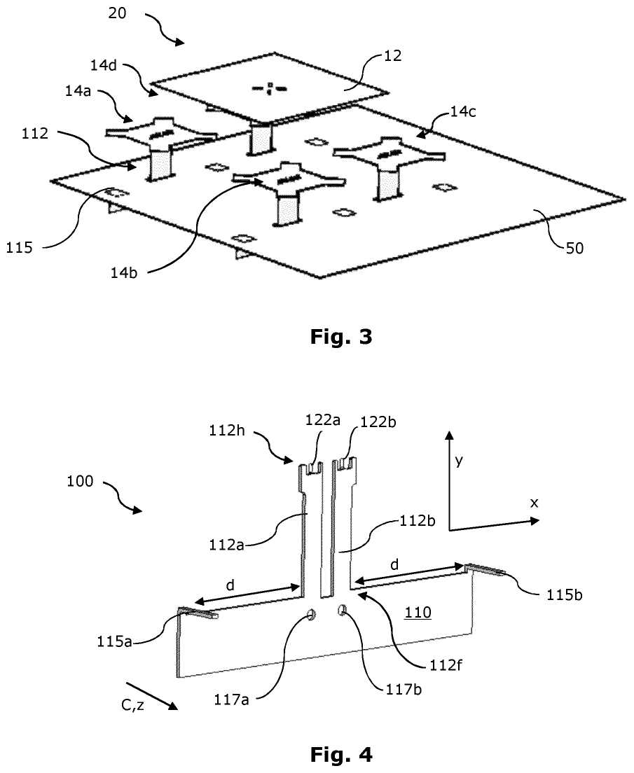

The control unit 40 is connected via respective data lines to the radio units 31, 32. Each one of the radio units 31, 32 powers a respective base station antenna (i.e. multi-band antennas 10, 20), or at least parts thereof. The base station antennas may be multi-band antennas 10, 20 as shown in FIGS. 2 and 3.

FIG. 2 is schematic illustration (top view) of a multiband antenna 10 according to an embodiment. The multiband antenna 10 includes multiple (six) dual polarized dipoles 14a-f, each including two high band radiating elements 14a1-14f2. First high band radiating elements 14a1, 14b1, 14c1, 14d1, 14e1, 14f1 and second high band radiating elements 14a2, 14b2, 14c2, 14d2, 14e2, 14f2 may form respective dual polarized dipoles 14a-f, wherein the first high band radiating element 14a1, 14b1, 14c1, 14d1, 14e1, 14f1 may have a first polarization (e.g. +45 degree) and wherein the second high band radiating element 14a2, 14b2, 14c2, 14d2, 14e2, 14f2 may have a second polarization (e.g. −45 degree).

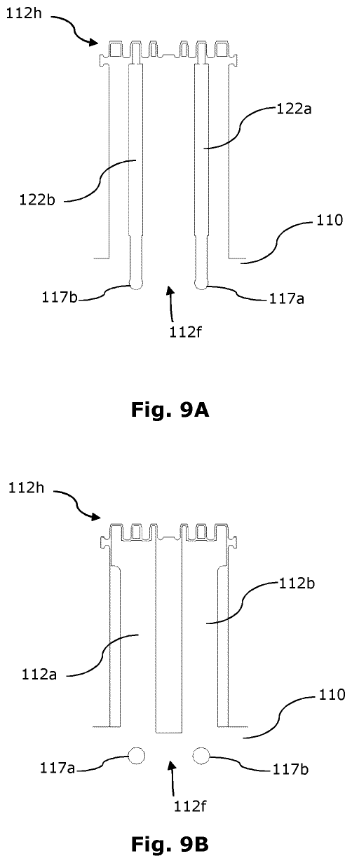

Each high band radiating element 14a1-14f2 includes a first dipole arm 41; 43 and a second dipole arm 42; 44. Further, the multiband antenna 10 includes at least one low band radiating element 12. There may be multiple low band radiating elements, wherein a first and second low band radiating element may form a dual polarized radiator for the low band. Said low band radiating element 12 is an interspersed low band radiating element, being centered and placed above the high band radiating elements 14a1-14f2. The multiband antenna includes further at least one electrically conductive grounding structure (as e.g. depicted in FIGS. 3 to 8). A respective ground line of the electrically conductive grounding structure as well as a signal transmission line is assigned to each of the high band radiating elements (cf. e.g. FIGS. 9A and 9B).

FIG. 3 is schematic illustration (perspective view) of a multiband antenna 20 according to an embodiment. The multiband antenna 20 includes multiple (four) dual polarized dipoles 14a-d, each including two high band radiating elements (cf. e.g. FIG. 2). Each of the high band radiating elements is assigned to a ground line 112 of an electrically conductive grounding structure and serves one polarization. In FIGS. 2 and 3, the dual polarized dipoles 14a-f are arranged in an array. The dual polarized dipoles 14a-f and respective high band radiating elements 14a1-14f2 thereof being arranged in a row (or column) may be assigned to a single electrically conductive grounding structure as e.g. shown in FIGS. 3 to 8. In FIG. 3, a reflector element 50 is provided. The reflector element 50 is arranged between a main body portion of the electrically conductive grounding structure and the high band radiating elements forming the dual polarized dipoles 14a-d. Hence, the ground lines 112 penetrate and extend through the reflector element 50. To allow the ground lines to extend through the reflector element 50, the reflector element includes respective though openings (e.g. slots). In the embodiment shown in FIG. 3, the ground contacts 115 of the electrically conductive grounding structure are (capacitively) coupled to the reflector element 50.

FIG. 4 is a schematic illustration of an electrically conductive grounding structure 100 according to an embodiment. The electrically conductive grounding structure 100 is adapted for a dual polarized dipole having two high band radiating elements, respectively two ground lines 112a, 112b are provided. The electrically conductive grounding structure 100 comprises a main body portion 110, and said two ground lines 112a, 112b. The ground lines 112a, 112b extend from the main body portion 110 from a respective foot end 112f in a first direction y towards a respective head end 112h. The foot end 112f is provided at the main body portion 110 and the head end 112h is opposed to the foot end 112f. Further, the head end 112f is adapted to support a respective one of the high band radiating elements. Parallel to the ground lines 112a, 112b signal transmission lines may be rooted, likewise extending from the foot end towards the head end. In FIG. 4, the ends of the signal transmission lines 122a, 122b, which are routed parallel to the ground lines 112a, 112b (but largely hidden in the view of FIG. 4) are shown at the head end. A more detailed view of the routing of the signal transmission lines and the ground lines is shown in FIGS. 9A and 9B, respectively.

The electrically conductive grounding structure 100 may comprise or may be made of a sheet metal, a die cast, a micro-strip line or a PCB. In case of a sheet metal based electrically conductive grounding structure or a die cast based electrically conductive grounding structure, the respective signal transmission lines for feeding the radiating elements can be provided substantially parallel (at least in part) to the respective ground lines, while being separated and electrically insulated from the respective ground lines. The separation can be achieved by electrically insulating spacers (e.g. plastic screws and washers, rivets and/or the like).

In case of a micro strip line or PCB based electrically conductive grounding structure, the signal transmission lines for feeding the radiating elements can be provided on a first metallization layer of the micro strip line and/or the PCB, and the ground lines may be provided on a second metallization layer of the micro strip line and/or the PCB.

Further, the electrically conductive grounding structure 100 comprises a main body portion 110 having two ground contacts 115a, 115b. The ground contact 115a is assigned to the ground line 112a and the ground contact 115b is assigned to the ground line 112b. Both ground contacts 115a, 115b are provided in a distance d from the respective foot end of the assigned ground line 112a, 112b. The distance d is measured in a second direction x being different (here perpendicular) than the first direction y.

In FIG. 4, the distances d of the first and second ground contacts 115a, 115b are equal and are chosen so as to shift the common mode, CM, resonance of the high band radiating elements 14 out of a used frequency range of a low-band radiating element 12 of the multiband antenna 10.

Further, the main body portion 110 includes two feeding points 117a, 117b. The feeding point 117a is assigned to the high band radiating element supported by the ground line 112a and the feeding point 117b is assigned to the high band radiating element supported by the ground line 112b. Said feeding points 117a, 117b serve for connecting e.g. coaxial signal lines to respective radiating elements, having different polarizations. A connection direction C of the coaxial signal lines is here in a direction z being substantially perpendicular to the first direction y and second direction x.

FIG. 5 is a schematic illustration of an electrically conductive grounding structure 100′ according to an embodiment. The electrically conductive grounding structure 100′ is adapted for twos dual polarized dipoles, each having two high band radiating elements, respectively four ground lines 112a, 112b; 113a, 113b are provided. The electrically conductive grounding structure 100′ comprises a main body portion 110′, and said ground lines 112a, 112b; 113a, 113b. The ground lines 112a, 112b extend from the main body portion 110 from a respective foot end 112f in a first direction y towards a respective head end 112h. The foot end 112f is provided at the main body portion 110 and the head end 112h is opposed to the foot end 112f. Further, the head end 112f is adapted to support a respective one of the high band radiating elements. The ground lines 113a, 113b extend from the main body portion 110′ from a respective foot end 113f in a first direction y towards a respective head end 113h. The foot end 113f is provided at the main body portion 110′ and the head end 113h is opposed to the foot end 113f. Further, the head end 113f is adapted to support a respective one of the high band radiating elements.

Parallel to the ground lines 112a, 112b and 113a, 113b signal transmission lines may be rooted, likewise extending from the foot end towards the head end. In FIG. 5, the ends of the signal transmission lines 122a, 122b, 123a, 123b which are routed parallel to the ground lines 112a, 112b, 113a, 113b (but largely hidden in the view of FIG. 5) are shown at the head end. A more detailed view of the routing of the signal transmission lines and the ground lines is shown in FIGS. 9A and 9B, respectively. The electrically conductive grounding structure 100′ may comprise or may be made of a sheet metal, a die cast, a micro-strip line or a PCB as outlined with respect to the embodiment shown in FIG. 4.

Further, the electrically conductive grounding structure 100 has three ground contacts 115a, 115b, 115c. The ground contact 115a is assigned to the ground line 112a and the ground contact 115c is assigned to the ground line 113b. The ground contact 115b is a shared ground contact, being assigned to the ground lines 112b and 113a.

The ground contacts 115a, 115b, 115c are provided in a distance da, d2 from the respective foot end of the assigned ground lines 112a, 112b, 113a, 113b. The distances d1, d2 are measured in a second direction x being different (here perpendicular) than the first direction y. In FIG. 5, the distances d1 and d2 may be equal. Hence, ground contact 115b may be centered between ground lines 112b and 113a. In any case, the distances are chosen so as to shift the common mode, CM, resonance of the high band radiating elements 14 out of a used frequency range of a low-band radiating element 12 of the multiband antenna 10.

Further, the main body portion 110 includes four feeding points 117a, 117b; 118a, 118b for feeding the respective radiating elements and for connecting e.g. coaxial signal lines. A connection direction C of the coaxial signal lines is here in a direction z being substantially perpendicular to the first direction y and second direction x. In FIGS. 4 and 5 the ground contacts 115a-c are galvanically coupling ground contacts. I.e. they are adapted to be galvanically connected (welded, soldered, screwed, . . . ) to a reflector element or base plate of a multiband antenna.

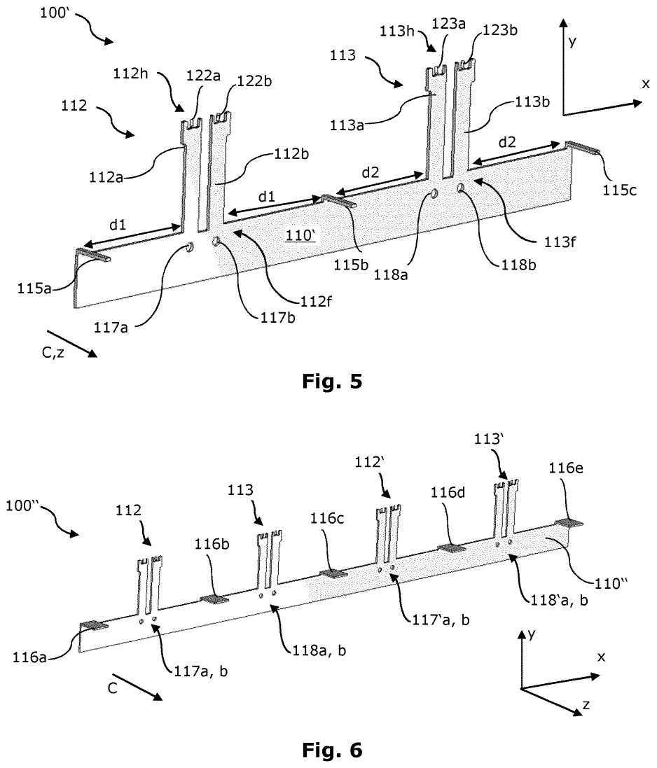

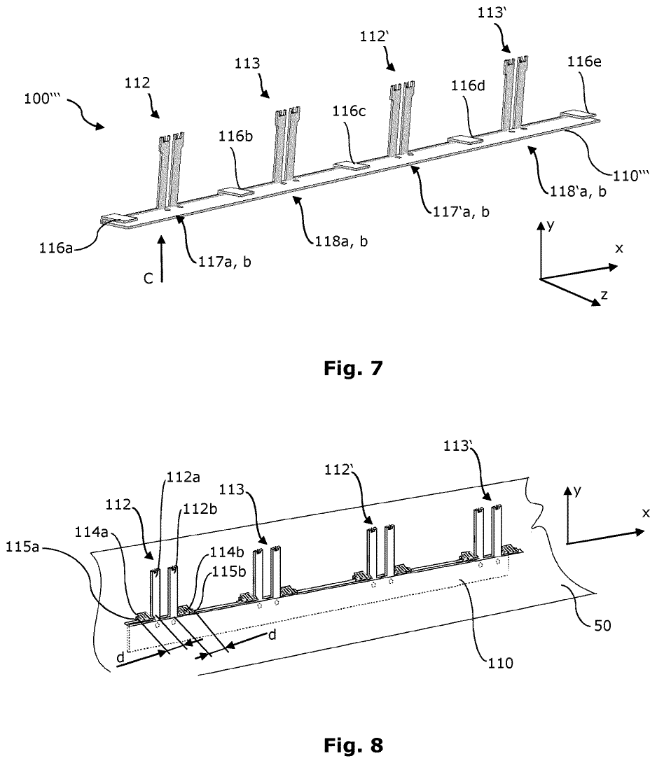

FIGS. 6 and 7 are schematic illustrations of an electrically conductive grounding structure 100″ and 100′″, respectively. The electrically conductive grounding structure 100″ and 100′″ are adapted for four dual polarized dipoles, each having two high band radiating elements, respectively four pairs of ground lines 112, 112′; 113 and 113′ are provided. Parallel to the ground lines of the pairs of ground lines signal transmission lines may be rooted (not shown). The electrically conductive grounding structures 100″, 100″ may comprise or may be made of a sheet metal, a die cast, a micro-strip line or a PCB as outlined with respect to the embodiment shown in FIG. 4.

Further, the electrically conductive grounding structures 100″, 100′″ have five ground contacts 116a-e, each one assigned to a respective ground line. Between two neighboring pairs of ground lines, a shared ground contact 116b-d is provided. The distances between the ground contacts and the respective ground lines are chosen so as to shift the common mode, CM, resonance of the high band radiating elements 14 out of a used frequency range of a low-band radiating element 12 of the multiband antenna 10. In FIGS. 6 and 7 the ground contacts 116a-e are capacitively coupling ground contacts. I.e. they are adapted to be capacitively coupled to a reflector element or base plate of a multiband antenna.

Further, the main body portions 110″ and 110′″ include eight feeding points 117a, 117b; 118a, 118b; 117′a, 117′b; 118′a, 118′b for feeding the respective radiating elements and for connecting e.g. coaxial signal lines. In FIG. 6, the main body portion 110″ is oriented in a way that a connection direction C of the coaxial signal lines is in a direction z being substantially perpendicular to the first direction y and second direction x. In FIG. 7, the main body portion 110′″ is oriented in a way that a connection direction C of the coaxial signal lines is the first direction y.

FIG. 8 shows a schematic illustration of n further electrically conductive grounding structure according to an embodiment. Here, the electrical line length between a ground contact 115a, 115b and a foot end of an assigned ground line 112a, 112b of a pair of ground lines 112 is longer than the distance d measured in the second direction x. This is achieved by providing a meandering electrical line 114a, 114b. Said meandering electrical line may be formed of sheet metal or of a die cast or may be provided on a micro strip line or a PCB. Likewise, a meandering electrical line may be provided between respective ground contacts and a foot end of an assigned ground line of a pair of ground lines 112′, 113, 113′, so as to provide an electrical line length between said ground contact and a foot end that is longer than the distance d measured in the second direction x. Further, a reflector element 50 is shown in FIG. 8. The reflector element 50 is arranged between the main body portion 110 of the electrically conductive grounding structure and a head end of the ground lines 112a, 112b of a pair of ground lines 112. The ground contacts 115a, 115b of the electrically conductive grounding structure 110 are coupled to the reflector element 50. The coupling may be galvanically and/or capacitively.

FIGS. 9A and 9B show a detailed view of an electrically conductive grounding structure, particularly of the signal transmission lines 122a, 122b (cf. FIG. 9A) and the ground lines 112a, 112b (cf. FIG. 9B), thereof. FIG. 9A gives a detailed view of the electrically conductive grounding structure showing a signal transmission line side, while FIG. 9B shows the opposite side, i.e. a ground line side of the electrically conductive grounding structure.

The electrically conductive grounding structure shown in this detailed views is an electrically conductive grounding structure having an integrated feeding structure. The feeding structure serves for feeding transmission signals via the signal transmission lines 122a, 122b from an assigned feeding point 117a, 117b to the respective radiating elements (not shown). Hence, the signal transmission lines 122a, 122b are routed substantially parallel to the ground lines 112a, 112b from a foot end 112f to a head end 112h. The head end 112h is opposed to the respective foot end 112f and is adapted to support the at least one high band radiating element.

For integrating the feeding structure, the ground lines 112a, 112b and the signal transmission lines 122a, 122b may be provided on a PCB having at least two metallization layers, wherein the signal transmission lines 122a, 122b are separated from the electrically conductive grounding structure (and respective ground lines 112a, 122b) by the PCB's substrate (i.e. a dielectric medium).

Here, the feeding points 117a, 117b are localized in close proximity to a foot end 112f of the assigned ground lines 112a, 112b. The location of the feeding point may be chosen so as to shift the common mode, CM, resonance of the at least one high band radiating element out of a used frequency range of a low-band radiating element of the multiband antenna.

As shown in FIG. 9A a first signal transmission line 122a is adapted to connect a first feeding point 117a with an assigned first high band radiating element and a second signal transmission line 112b is adapted to connect a second feeding point 117b with an assigned second high band radiating element. Further, as shown in FIG. 9B a first ground line 112a is routed substantially parallel to the first signal transmission line 122a and adapted to connect a first feeding point 117a with an assigned first high band radiating element. Likewise, a second ground line 112b is routed substantially parallel to the second signal transmission line 112b and adapted to connect a second feeding point 117b with an assigned second high band radiating element. The first and second high band radiating elements may form a dual polarized radiator, wherein the first high band radiating element may have a first polarization (e.g. +45 degree) and wherein the second high band radiating element may have a second polarization (e.g. −45 degree).

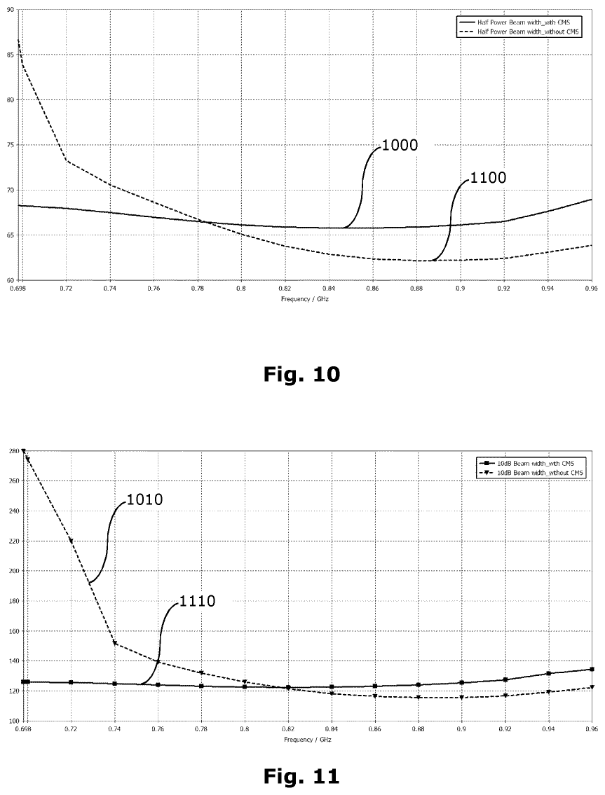

FIG. 10 shows a 3 dB (half power) and FIG. 11 shows a 10 dB horizontal beam width of an exemplary multiband antenna. Graph 1000 shows a half power beam width with inventive grounding structure and graph 1100 shows a half power beam width without inventive grounding structure, where the grounding was done directly below the high band radiating element(s). Graph 1010 shows a 10 dB beam width with inventive grounding structure and graph 1110 shows a 10 dB beam width without inventive grounding structure. As shown, the beam width is significantly distorted by direct grounding below the high band radiating elements. However, by specifically defined ground contacts, as according to the invention, the radiation patterns of the low band element have been recovered and stabilized over the whole bandwidth.

Some of the embodiments contemplated herein are described more fully with reference to the accompanying figures. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

### LIST OF REFERENCE SIGNS

1 base station
10 multi band antenna (e.g. a base station antenna)
12 low-band radiating element
14a dual polarized dipole
14b dual polarized dipole
14c dual polarized dipole
14d dual polarized dipole
14e dual polarized dipole
14f dual polarized dipole
14a1 high band radiating element
14a2 high band radiating element 14b1 high band radiating element
14b2 high band radiating element
14c1 high band radiating element
14c2 high band radiating element
14d1 high band radiating element
14d2 high band radiating element
14e1 high band radiating element
14e2 high band radiating element
14f1 high band radiating element
14f2 high band radiating element
40 control unit, e.g. a base band unit (BBU)
41 first dipole arm (first dipole)
42 second dipole arm (first dipole)
43 first dipole arm (second dipole)
44 second dipole arm (second dipole)
50 reflector element
100 electrically conductive grounding structure
100′ electrically conductive grounding structure
100″ electrically conductive grounding structure
100′″ electrically conductive grounding structure
110 main body portion
110′ main body portion
110″ main body portion
110′″ main body portion
112 pair of ground lines
112′ pair of ground lines
112a first ground line (assigned to first dipole)
112b second ground line (assigned to second dipole)
112f foot end
112h head end
113 pair of ground lines
113′ pair of ground lines
113a first ground line (assigned to first dipole)
113b second ground line (assigned to second dipole)
113f foot end
113h head end
114a meandering electrical line
114b meandering electrical line
115a ground contact (galvanic)
115b ground contact (galvanic)
115c ground contact (galvanic)
116a ground contact (capacitive)
116b ground contact (capacitive)
116c ground contact (capacitive)
116d ground contact (capacitive)
116e ground contact (capacitive)
117a feeding point
117b feeding point
117′a feeding point
117′b feeding point
118a feeding point
118b feeding point
118′a feeding point
118′b feeding point
122a signal transmission line
122b signal transmission line
123a signal transmission line
123b signal transmission line
1000 measured half power beam width (with inventive grounding structure)
1100 measured half power beam width (without inventive grounding structure)
1010 measured 10 dB beam width (with inventive grounding structure)
1110 measured 10 dB beam width (without inventive grounding structure)
d distance
d1 distance
d2 distance
X second direction
y first direction
Z third direction

1. An electrically conductive grounding structure for at least one high band radiating element of a multiband antenna, the grounding structure comprising:
a main body portion; and
at least one ground line the ground line extending from the main body portion from a foot end in a first direction towards a head end;
wherein the foot end is provided at the main body portion, and wherein the head end is opposed to the respective foot end and is adapted to support the at least one high band radiating element;
wherein the main body portion further comprises at least one ground contact, the ground contact assigned to and electrically connected with the at least one ground line;
wherein the at least one ground contact is provided in a distance from the foot end of the assigned ground line; and
wherein the distance is measured in a second direction being different than the first direction, and wherein the distance is chosen so as to shift the common mode (CM) resonance of the at least one high band radiating element out of a used frequency range of a low-band radiating element of the multiband antenna.

2. The electrically conductive grounding structure according to claim 1, wherein:
the grounding structure has multiple ground line, each ground line extending towards a respective head end and being assigned to a high band radiating element of a multiband antenna;
the main body portion further comprises multiple ground contacts, wherein at least one ground contact of the multiple ground contacts is assigned to and electrically connected with a respective one of the ground lines;
the ground contacts are provided in a distance from a foot end of the assigned ground line, and
the distance is measured in a second direction being different than the first direction, and wherein the distance is chosen so as to shift the common mode (CM) resonance of the respective high band radiating elements out of a used frequency range of a low-band radiating element of the multiband antenna.

3. The electrically conductive grounding structure according to claim 1, wherein:
a distance of a first ground contact being assigned to a first ground line equals a distance of a second ground contact being assigned to a second ground line, wherein the first and second ground lines may be assigned to a dual polarized high band radiating element.

4. The electrically conductive grounding structure according to claim 1, wherein:
the electrical line length between a ground contact and a foot end of an assigned ground line may be longer than the distance measured in the second direction, and wherein the electrical line length may be lengthened by means of a meandering electrical line.

5. The electrically conductive grounding structure according to claim 1, wherein:
at least one ground contact is a capacitively coupled ground contact or a galvanically coupled ground contact.

6. The electrically conductive grounding structure according to claim 1, wherein:
the electrically conductive grounding structure comprises or is made of a sheet metal, a die cast, a micro-strip line or a PCB, particularly of a single metallization layer of the PCB.

7. The electrically conductive grounding structure according to claim 1, further comprising:
at least one feeding point, the feeding point being assigned to the high band radiating element supported by the ground line;
wherein the feeding point serves for connecting a coaxial signal line, wherein a connection direction of the coaxial signal line may be the first direction, or a direction being substantially perpendicular to the first direction and second direction, and wherein the feeding point may be localized in close proximity to a foot end of the assigned ground line.

8. A high band antenna element for a multiband antenna, the high band antenna element comprising:
at least one high band radiating element and a signal transmission line, wherein the high band radiating element is fed by the signal transmission line; and
the electrically conductive grounding structure according to claim 1, wherein the electrically conductive grounding structure is assigned to the at least one high band radiating element, wherein the signal transmission line may be integrated in the electrically conductive grounding structure.

9. A multiband antenna, the multiband antenna comprising:
at least one low band radiating element, which may be an interspersed low band radiating element;
at least one high band radiating element; and
at least one electrically conductive grounding structure for the at least one high band radiating element of the multiband antenna, the at least one grounding structure comprising:
a main body portion; and
at least one ground line, the ground line extending from the main body portion from a foot end in a first direction towards a head end;
wherein the foot end is provided at the main body portion, and wherein the head end is opposed to the respective foot end and is adapted to support the at least one high band radiating element;
wherein the main body portion further comprises at least one ground contact, the ground contact assigned to and electrically connected with the at least one ground line;
wherein the at least one ground contact is provided in a distance from the foot end of the assigned ground line;
wherein the distance is measured in a second direction being different than the first direction, and wherein the distance is chosen so as to shift the common mode (CM) resonance of the at least one high band radiating element out of a used frequency range of a low-band radiating element of the multiband antenna; and
wherein the at least one ground line of the electrically conductive grounding structure is assigned to the at least one high band radiating element.

10. The multiband antenna according to claim 9, wherein:
at least one of the radiating elements are fed with one of a sheet metal, a micro strip line and/or at least one PCB.

11. The multiband antenna according to claim 10, wherein:
each radiating element is fed by a single PCB, the PCB being preferably a dual layer PCB.

12. The multiband antenna according to claim 9, further comprising:
a parasitic metal, the parasitic metal being provided so as to sandwich a high band radiating element between the parasitic metal and a head end of a ground line of the electrically conductive grounding structure.

13. The multiband antenna according to claim 9, further comprising:
a reflector element and/or a base plate, wherein the reflector element may be arranged between the main body portion and the at least one high band radiating element, and wherein the at least one ground contact of the electrically conductive grounding structure is coupled to the reflector element and/or the base plate.

14. The multiband antenna according to claim 9, wherein:
the at least one high band radiating element is fed with a signal line, the signal line being arranged in parallel to the ground line, particularly broadside coupled.

15. A base station for mobile communication, the base station comprising:
at least one multiband antenna comprising:
at least one low band radiating element, which may be an interspersed low band radiating element:
at least one high band radiating element; and
at least one electrically conductive grounding structure for the at least one high band radiating element of the multiband antenna, the at least one grounding structure comprising:
a main body portion; and
at least one ground line, the ground line extending from the main body portion from a foot end in a first direction towards a head end;
wherein the foot end is provided at the main body portion, and wherein the head end is opposed to the respective foot end and is adapted to support the at least one big band radiating element;
wherein the main body portion further comprises at least one ground contact, the ground contact assigned to and electrically connected with the at least one ground line:
wherein the at least one ground contact is provided in a distance from the foot end of the assigned ground line:
wherein the distance is measured in a second direction being different than the first direction, and wherein the distance is chosen so as to shift the common mode (CM) resonance of the at least one high band radiating element out of a used frequency range of a low-band radiating element of the multiband antenna: and
wherein the at least one ground line of the electrically conductive grounding structure is assigned to the at least one high band radiating element; and
at least one radio unit being assigned to the multiband antenna.
